(19) United States
(12) Patent Application Publication
(10) Pub. No.: US 2012/0117850 A1
(43) Pub. Date: May 17, 2012

(54) FISHING BOAT AND METHOD FOR CATCHING FISH

(76) Inventor: Vlatko Panovic, Burnaby (CA)

(21) Appl. No.: 13/386,080

(22) PCT Filed: Jul. 16, 2010
(86) PCT No.: PCT/CA10/01094

§ 371 Date: Jan. 20, 2012

Related U.S. Application Data
(60) Provisional application No. 61/271,223, filed on Jul. 20, 2009.

(51) Int. Cl. A01K 79/00; B63B 1/10; B60Q 1/00; B63B 39/03; A01K 97/02; B63B 35/14; B63B 35/26

(52) U.S. Cl. 43/4.5; 114/255; 43/44.99; 362/477

(57) ABSTRACT

The present invention relates to a multi-hull fishing boat having a bow, a stern opposite the bow and a bottom. The boat includes a pair of spaced-apart pontoons operatively connected together. The boat includes a first gate near the bow of the boat configured to selectively extend across the space between the pair of pontoons. The boat includes a second gate near the stern of the boat configured to selectively extend across the space between the pair of pontoons. The boat includes a third gate configured to selectively extend across the space between the pair of pontoons by the bottom of the boat. The first gate, the second gate, the third gate and the pair of pontoons form an enclosure for trapping fish.

### CROSS REFERENCE TO RELATED APPLICATION

This application claims the benefit of provisional application 61/271,223 filed in the United States Patent and Trademark Office on Jul. 20, 2009, the disclosure of which is incorporated herein by reference and priority to which is claimed.

### FIELD OF THE INVENTION

The present invention relates to a boat. In particular, the invention relates to a fishing boat and a method for catching fish therewith. The fishing boat and method as herein described may be referred to as netless fishing or as a floating fish trap.

### DESCRIPTION OF THE RELATED ART

There are a number of different types of fishing boats and systems for catching fish. However there is a need for an improved fishing boat and method for catching fish therewith for some applications.

### BRIEF SUMMARY OF INVENTION

It is an object of the present invention to provide an improved fishing boat and method for catching fish therewith.

There is accordingly provided a multi-hull fishing boat having a bow, a stern opposite the bow and a bottom. The boat includes a pair of spaced-apart pontoons operatively connected together. The boat includes a first gate near the bow of the boat configured to selectively extend across the space between the pair of pontoons. The boat includes a second gate near the stern of the boat configured to selectively extend across the space between the pair of pontoons. The boat includes a third gate configured to selectively extend across the space between the pair of pontoons by the bottom of the boat. The first gate, the second gate, the third gate and the pair of pontoons form an enclosure for trapping fish.

There is also provided a fishing boat for capturing fish. The boat includes a hollow hull with a hull interior and an opening for communication with the hull interior and surrounding water. The boat includes a gate adjacent to the opening. The gate is configured to open and allow water to at least partially enter into the hull. The boat becomes more submerged thereby. The boat includes a means for attracting fish into the hull interior. The gate is configured to selectively close and capture the fish.

There is further provided a method of fishing for a catamaran fishing boat. The boat has a bow, a stern opposite the bow, a bottom and a pair of pontoons. The method includes configuring the fishing boat with a first gate, a second gate and a third gate which are selectively positionable and extendable between the pair of pontoons adjacent the bow, the stern and the bottom of the boat, respectively. An enclosure is formed thereby. The method includes positioning and extending at least one of the first gate, the second gate and the third gate between the pair of pontoons. The method includes deploying one of bait and light adjacent to one of the gates while the one of the gates is at least partially open so as to attract fish thereby. The method includes so positioning and extending the gates, apart from the one of the gates, between the pair of pontoons in such a manner as to catch the fish within the enclosure.

### BRIEF DESCRIPTION OF DRAWINGS

The invention will be more readily understood from the following description of preferred embodiments thereof given, by way of example only, with reference to the accompanying drawings, in which:

FIG. 1 is a simplified side elevation view of a multi-hull fishing boat having a pair of pontoons and being in a low drag mode according to one embodiment;

FIG. 2 is a front elevation view of the fishing boat shown in FIG. 1 with a first exterior gate shown in a fully raised position, the first exterior gate having netting;

FIG. 3 is an end elevation view of the first exterior gate shown in FIG. 2, the first exterior gate being shown in isolation;

FIG. 4 is a rear elevation view of the fishing boat shown in FIG. 1 with a second exterior gate shown in a fully raised position, the second exterior gate having netting;

FIG. 5 is a magnified rear elevation view of part of a third gate mechanism shown in FIG. 4 mounted to one of the pair of pontoons of the boat;

FIG. 6 is a top plan view of the fishing boat shown in FIG. 1;

FIG. 7 is a sectional end view of the fishing boat shown in FIG. 6 taken along the lines 7-7 and showing a pair of ballast control mechanisms disposed within the pair of pontoons, the pair of ballast control mechanisms being in a buoyancy mode;

FIG. 8 is a magnified sectional end view of part of one of the pair of ballast control mechanisms shown in FIG. 7, showing a motor with a flange connected thereto in a closed position;

FIG. 9 is a sectional end view of the fishing boat shown in FIG. 6 taken along the lines 7-7 and showing the pair of ballast control mechanisms in a submersion mode and the fishing boat partially submerged;

FIG. 10 is a magnified sectional end view of part of one of the pair of ballast control mechanisms shown in FIG. 9 showing the motor with the flange connected thereto in an open position;

FIG. 11 is a side elevation view of the fishing boat shown in FIG. 9;

FIG. 12 is a front elevation view of the fishing boat shown in FIG. 11 with the first exterior gate shown in a fully lowered position;

FIG. 13 is a sectional end elevation view of the fishing boat shown in FIG. 11 taken along the lines 13-13, with the third exterior gate shown in a partially lowered position;

FIG. 14 is a sectional end elevation view of the fishing boat shown in FIG. 11 taken along the lines 13-13 with the third exterior shown in a fully lowered position;

FIG. 15 is a simplified, partially sectional, side elevation view of the fishing boat shown in FIG. 14, with bait being released adjacent to the second exterior gate and into an enclosure of the boat made by the first exterior gate, the second exterior gate and the third exterior gate, fish entering the enclosure and the second exterior gate being in a partially lowered position;

FIG. 16 is a simplified, partially sectional, side elevation view of the fishing boat shown in FIG. 15 with the second exterior gate being in a fully lowered position and the fish being caught within the fishing boat;

FIG. 17 is a simplified, partially sectional, elevation view of a fishing boat according to a second embodiment, with the boat having light apparatuses illuminating the enclosure and fish being attracted to the light and entering the enclosure thereby;

FIG. 18 is a simplified, partially sectional, elevation view of a fishing boat according to a third embodiment, with a second boat having a light apparatus illuminating the enclosure and fish being attracted to the light and entering the enclosure thereby;

FIG. 19 is a simplified, sectional end view of a monohull fishing boat according to a fourth embodiment, the fishing boat being in a low drag mode and a pair of ballast control mechanisms being in a buoyancy mode;

FIG. 20 is a sectional end view of the fishing boat shown in FIG. 19 showing the pair of ballast control mechanisms in a submersion mode, the pair of ballast control mechanisms having flanges in open positions and the fishing boat being partially submerged;

FIG. 21 is a sectional end view of the fishing boat shown in FIG. 20, showing a hull interior of the fishing boat partially filed with water and fish, showing the flanges of the pair of ballast control mechanisms in closed positions and showing pumps which are ejecting water from the hull interior and causing the boat to return towards the low drag mode of FIG. 19;

FIG. 22 is a simplified, partially sectional, side elevation view of a fishing boat according to a fifth embodiment, the fishing boat being in a partially submerged mode and having at its bottom a plurality of axially rotatable gates in closed positions;

FIG. 23 is a partially schematic, bottom plan view of the fishing boat shown in FIG. 22, with the plurality of axially rotatable gates and a plurality of motors, respectively, connected thereto;

FIG. 24 is a simplified, partially sectional, side elevation view of the fishing boat shown in FIG. 22, the plurality of axially rotatable gates being in fully open positions, with bait being released adjacent to the second exterior gate and into an enclosure of the boat made by the first exterior gate, the second exterior gate, and the rotatable gates, and fish entering the enclosure;

FIG. 25 is a simplified, top plan view of a fishing boat according to a sixth embodiment showing an interior gate mechanism and a plurality of slidable interior gates, the plurality of interior gates being in fully raised positions;

FIG. 26 is a side elevation view of the fishing boat shown in FIG. 25, the fishing boat being partially submerged;

FIG. 27 is a simplified, partially sectional, side elevation view of the fishing boat shown in FIG. 25 taken along the lines 27-27, with one of the plurality of interior gates connected to a winch and being in a partially lowered position;

FIG. 28 is a simplified, partially sectional, side elevation view of the fishing boat shown in FIG. 27 with said one of the plurality of interior gates in a fully lowered positions, mounted on a pair of spaced-apart brackets of the interior gate mechanism and in the process of being moving along an enclosure of the fishing boat by the winch;

FIG. 29 is a partially schematic, sectional view of the fishing boat shown in FIG. 28 taken along the lines 29-29, showing the pair of brackets of the interior gate mechanism in more detail;

FIG. 30 is an end elevation view of one of the plurality of interior gates shown in FIGS. 28 and 29 and an end view of the pair of brackets of the interior gate mechanism receiving said one of the plurality of interior gates;

FIG. 31 is a simplified, partially sectional, side elevation view of the fishing boat shown in FIGS. 25 to 30, with the plurality of interior gates in fully lowered positions and slidably adjusted within the enclosure for compartmentalizing fish caught thereby; and

FIG. 32 is a simplified front elevation view of a fishing boat according to a seventh embodiment with an exterior gate in the form of a wall.

### DESCRIPTION OF THE PREFERRED EMBODIMENTS

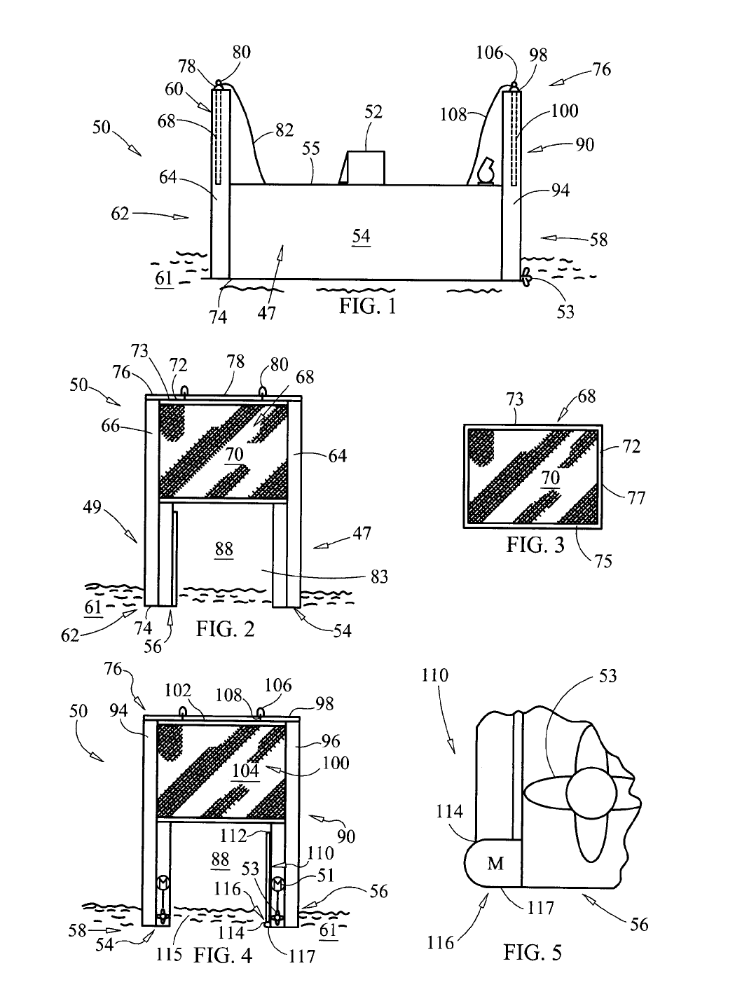

Referring to FIG. 1 there is provided a fishing boat 50. As shown in FIG. 2 the boat 50 in this embodiment is a multi-hull craft that includes a pair of elongated pontoons, in this example, including pontoon 54 disposed by a port side 47 of the boat and pontoon 56 spaced-apart from the first pontoon 54. Pontoon 56 is disposed by a starboard side 49 of the boat, the starboard side 49 being opposite the port side 47. Pontoons 54 and 56 at least partially surround space 88 located between the pontoons.

Referring back to FIG. 1 the boat 50 includes a deck 55 and a cockpit 52 mounted thereon for controlling and steering the boat 50. As best shown in FIG. 4 the boat 50 has a pair of motors 51 that are operatively connected to and actuate a pair of propellers 53, respectively for propelling the boat 50. The pair of propellers 53 are disposed on the pontoons 54 and 56, respectively, at the stern 58 of the boat 50. The propellers 53, motors 51 and related steering mechanisms of the boat 50 are all conventional and well known to those skilled in the art. They will thus not be discussed in further detail. Other propulsion means such as outboard motors could be substituted.

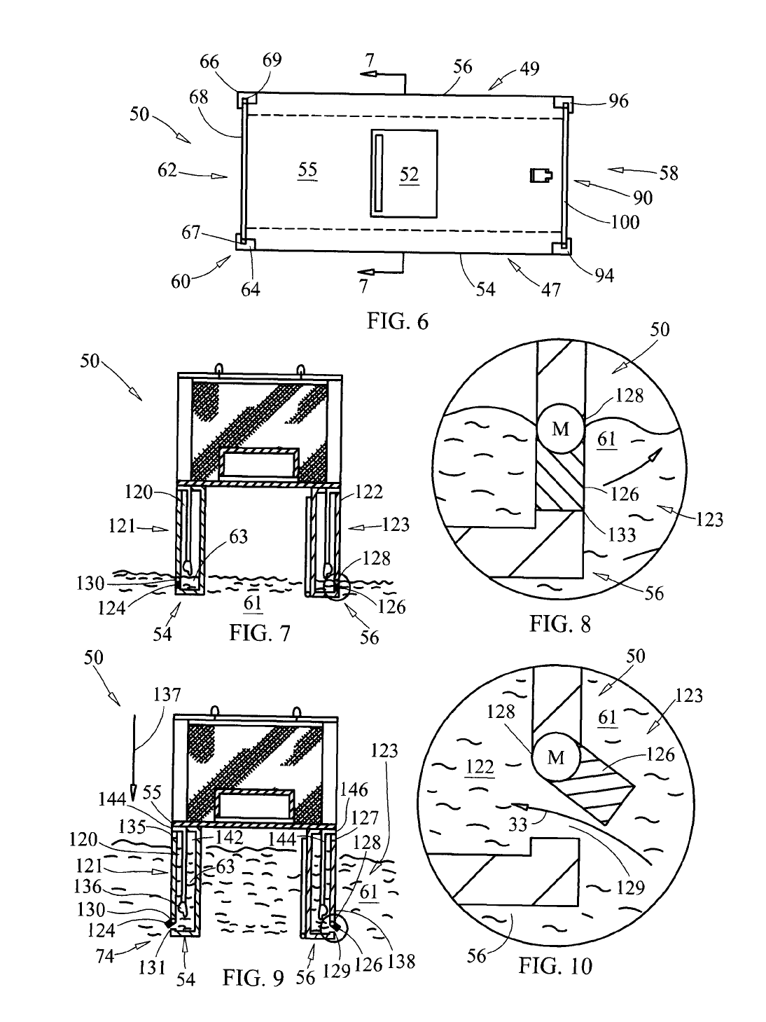

A top plan view of the boat 50 is shown in FIG. 6. FIG. 7 is a sectional elevation end view of the boat 50 showing that the pontoons 54 and 56 are at least partially hollow and have interiors 120 and 122, respectively.

FIGS. 1, 2, 4 and 7 show the boat 50 in a low drag mode where the pontoons are raised substantially above the water.

The boat 50 includes a pair of ballast control mechanisms 121 and 123 for selectively controlling the amount of water 63 within the pontoons, and thus the degree to which the boat 50 is submerged in water 61. FIG. 7 shows the pair of ballast control mechanisms 121 and 123 in a buoyancy mode.

The ballast control mechanisms 121 and 123 include a means for selectively submerging the pair of pontoons into water 61, in this example in the form of a pair of motor-operated flanges 124 and 126. As best shown by way of example in FIG. 8, flange 126 is operatively connected to an actuator in this example a motor 128, shown in schematic form. Motor 128 is mounted on pontoon 56 in this example. Flange 126 and motor 128 are configured to enable the flange 126 to selectively from move a closed position shown in FIGS. 7 and 8 to an open position shown in FIGS. 9 and 10. Flange 126 is so shaped as to sealably extend across an opening 129 in the side of pontoon 56.

In the open position the opening 129 is exposed and water 61 as indicated by arrow 133 may thus enter into interior 122 of the pontoon 56. Water 61 is thus in communication with the interior 122 of the pontoon 56 when the flange 126 is in the open position. Pontoon 56 has a passageway 127 in communication with the interior 122, spaced-apart from and above water 61 and located adjacent to the deck 55 to enable air to exit from the interior 122 of the pontoon 56 as water 61 fills interior 122. This results in an increase in the ballast of the boat 50, causing the boat to become more and more submerged, sinking downwards from the perspective of FIG. 9 and as indicated by arrow 137. FIG. 9 shows the pair of ballast control mechanisms 121 and 123 in a submersion mode.

Once an operator of the boat 50 is satisfied with the extent to which the boat 50 is submerged, flange 126 is actuated by the motor 128 to return the flange 126 to its closed position shown in FIGS. 7 and 8. This causes opening 129 to be covered. Flange 126 so positioned inhibits water 61 from entering within the pontoon 56.

Flange 124, its motor 130, opening 131, and passageway 135 on pontoon 54 operate in a substantially similar manner to the equivalent components on pontoon 56 and therefore will not be described in detail.

Referring to FIG. 9 the ballast control mechanisms 121 and 123 further include a pair of ballast pumps 136 and 138 disposed within interiors 120 and 122, respectively, of the pontoons 54 and 56. Ballast pumps 136 and 138 are disposed near bottom 74 of the boat 50. Conduits 140 and 142 are operatively connected to the pumps 136 and 138, respectively, and extend to openings 144 and 146, respectively. Openings 144 and 146 are located adjacent to the deck 55 in this example, are spaced-apart from water 61 and are in communication with the outside air.

Thus, in operation the pumps 136 and 138 may be actuated to pump water 63 from within the interiors 120 and 122 of the pontoons 54 and 56, respectively, through conduits 140 and 142, to openings 144 and 146 and thus out of the boat 50. When the flanges 124 and 126 are in closed positions and the pumps 136 and 138 are so operated, the ballast may be selectively reduced, and buoyancy therefore increased, until the boat 50 is once again in the low drag mode as shown in FIGS. 1, 2, 4 and 7.

The gates of boat 50 will now be described. As best shown in FIG. 3 boat 50 includes a first gate, in this example a first exterior gate 68. The first exterior gate 68 in this example includes netting 70 and a frame in this example a rectangular frame 72. The size of the netting 70 may depend on the type of fish or marine life to be caught. The frame 72 is connected to and holds the netting 70 in place. Frame 72 has a top portion 73 disposable adjacent to top 76 of the boat 50, as shown in FIG. 2. Referring back to FIG. 3, frame 72 has a bottom portion 75 opposite the top portion 73, and a pair of spaced-apart frame portions 77 extending between and connected to both top portion 73 and bottom portion 75.

Referring to FIG. 2 the boat 50 has a first gate mechanism 60 disposed by bow 62 of the boat 50. The first gate mechanism 60 includes a pair of spaced-apart vertical supports, in this example, brackets 64 and 66, which are vertical from the perspective of FIG. 2. Brackets 64 and 66 extend from bottom 74 of the boat 50 towards top 76 of the boat 50 in this example. Bracket 64 is disposed adjacent to and along the port side 47 of the boat and is connected to pontoon 54. Bracket 66 is disposed adjacent to and along the starboard side 49 of the boat and is connected to pontoon 56. The brackets 64 and 66 have a channel, or u-shaped, cross-section as is best shown in FIG. 6. Brackets 64 and 66 are shaped to slidably receive the first exterior gate 68, having slots 67 and 69, respectively, for receiving the gate.

The first gate mechanism 60 includes a cross member 78 disposed in this example at the top 76 of the boat 50 as best shown in FIGS. 1 and 2. Cross member 78 has been omitted from FIG. 6 in order to show the cross-sectional shape of brackets 64 and 66. As shown in FIG. 2 cross member 78 extends between and connects to both brackets 64 and 66.

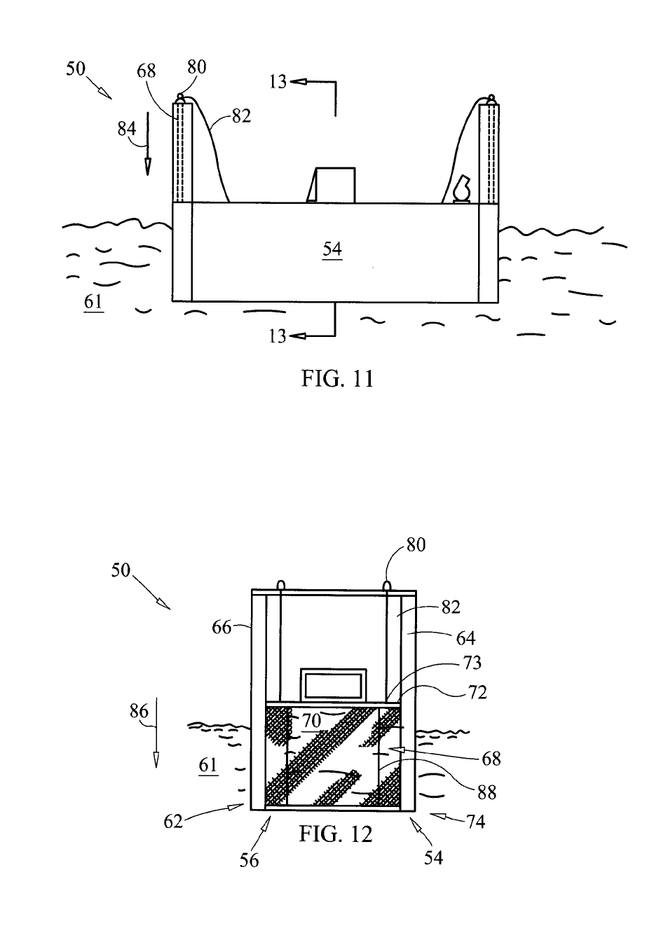

Referring to FIG. 12 a pair of pulleys 80 are mounted to the cross member 78. The boat 50 includes rope in this example a set of two ropes 82 that connect at one end to the top portion 73 of the frame 72 of the first exterior gate 68. The ropes 82 pass over the pair of pulleys 80.

When the ropes 82 are pulled in or coiled the first exterior gate 68 slides along the brackets 64 and 66 and is raised upwards from the position shown in FIG. 12 to a fully raised position shown in FIG. 2. The fully raised position is preferable when, for example, the boat is not fishing and/or when initially travelling to the fishing destination because it reduces boat drag.

When the ropes 82 are selectively released, the first exterior gate 68 is lowered downwards, from the perspective of FIGS. 11 and 12 and as indicated by arrows 84 and 86, to the fully lowered position shown in FIG. 12. In the fully lowered position bottom portion 75 of the first exterior gate 68 extends between the pontoons 54 and 56 adjacent to bottom 74 of the boat 50. Put another way the first exterior gate 68 spans opening 83 to the space 88, shown in FIG. 2, the opening 83 being between the pair of pontoons 54 and 56 at the bow 62 of the boat. Netting 70 so disposed inhibits fish and the like located within space 88 from exiting therefrom via opening 83 at the bow 62 of the boat 50.

Referring to FIG. 4 the boat 50 has a second gate mechanism 90 by stern 58 of the boat. The second gate mechanism 90 includes a pair of spaced-apart brackets 94 and 96 extending from top 76 of the boat 50 to bottom 74 of the boat 50. The second gate mechanism 90 includes a cross member 98 disposed along top 76 of the boat 50 and connected to and extending between the brackets 94 and 96. The boat 50 has a second gate in this example a second exterior gate 100 which includes a frame 102 and netting 104 mounted to and held in place by the frame 102.

Referring to both FIGS. 1 and 4 a pair of spaced-apart pulleys 106 are mounted to the cross member 98. A set of two ropes 108 pass through the pulleys 106 and operatively connect to the second exterior gate 100 via its frame 102. The second gate mechanism 90 and the second exterior gate 100 are substantially similar in construction and function to the first gate mechanism 60 and first exterior gate 68 and will thus not be described in further detail.

The boat 50 includes a third gate in this example a third exterior gate 110 as for example shown in FIG. 4. The gate 110 comprises a single integral wall member. However in other embodiments it may for example have a frame portion that surrounds and holds in place a netting as is for example shown for gate 68 in FIG. 3. The third exterior gate 110 has a first end 112 extending towards the top 76 of the boat 50 in the position shown in FIG. 4. The third exterior gate 110 is shown in a fully raised position in FIG. 4. The third exterior gate has a second end 114 opposite the first end 112. The second end 114 of the third exterior gate 110 is disposed adjacent to the bottom 74 of the boat 50 and adjacent to pontoon 56 in this example. The third exterior gate 110 is shaped so as to extend across and cover opening 115 located between the pontoons 54 and 56. Opening 115 extends along the full length of the boat 50 by bottom 74. In this example the gate 110 extends for substantially the full length of the boat between the bow 62 and stern 58.

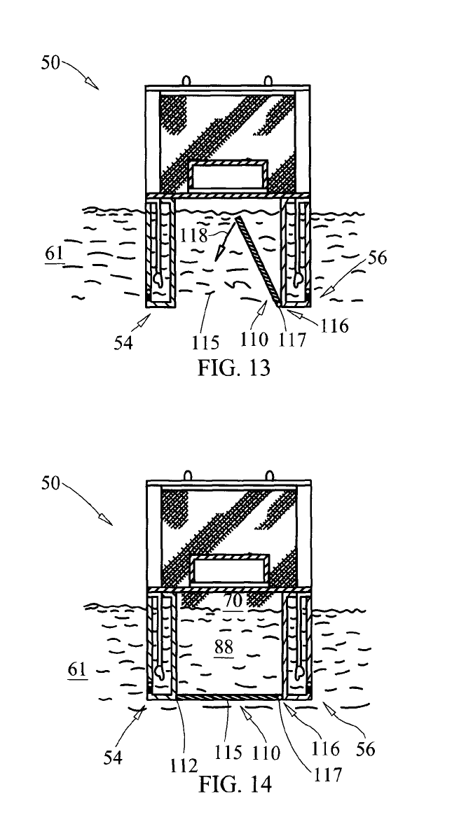

The boat 50 includes a third gate mechanism 116 which in this example comprises an actuator, in this example a motor 117, which is shown schematically in FIG. 5. Motor 117 is mounted to pontoon 56 and is operatively connected to the third exterior gate 110 at the second end 114 of the third exterior gate 110. Motor 117 is so configured as to selectively cause the third exterior gate 110 to rotate downwards and to the left from the perspective of FIG. 4, and as indicated by arrow 118 in FIG. 13.

FIG. 14 shows the third exterior gate 110 in a fully lowered position. The third exterior gate 110 fully extends across the opening 115 by the bottom 74 of the boat 50 between the pontoons 54 and 56 such that end 112 of the third exterior gate 110 abuts pontoon 54. The third exterior gate 110 in the fully lowered position thus inhibits fish and the like located within space 88 from exiting downwards, from the perspective of FIG. 14, and out of space 88, through now closed off opening 115, and away from the boat 50.

The third exterior gate 110 may be similarly raised upwards, from the perspective of FIG. 14, to the fully raised position shown in FIG. 4 when, for example, the boat is not fishing and/or when initially travelling to the fishing destination. The third exterior gate 110 in the fully raised position abuts pontoon 56 in this example and is thereby configured to reduce boat drag.

Thus FIGS. 1 to 7 show the boat 50 in the low drag mode with no water or relatively little water within the interiors 120 and 122 of the pontoons 54 and 56, respectively, as best shown in FIG. 7. This mode is preferable before the fishing has begun and the boat 50 is travelling to the fishing destination because the relatively low drag provided by the pontoons 54 and 56.

In view of the above the first gate mechanism 60, the second gate mechanism 90 and the third gate mechanism 116 thus may be selectively opened and this may be referred to as means for selectively opening or actuating at least one of the first gate, the second gate and the third gate.

The first exterior gate 68, the second exterior gate 100 and the third exterior gate 110 in fully lowered positions, together with pontoons 54 and 56 form an enclosure around space 88 that promotes the capture, retention and storage of fish and the like trapped therewithin.

The operation of fishing with boat 50 will now be described. In order to begin fishing the boat 50 is at least partially submerged via, in this example, moving flanges 124 and 126 to open positions, as shown in FIG. 9. The boat 50 as partially submerged is shown in FIGS. 9 and 11.

The first exterior gate 68 and the third exterior gate 110 are next actuated in this case lowered as shown in FIGS. 11 and 13, respectively, until they are in their fully lowered positions as shown in FIGS. 12 and 14, respectively.

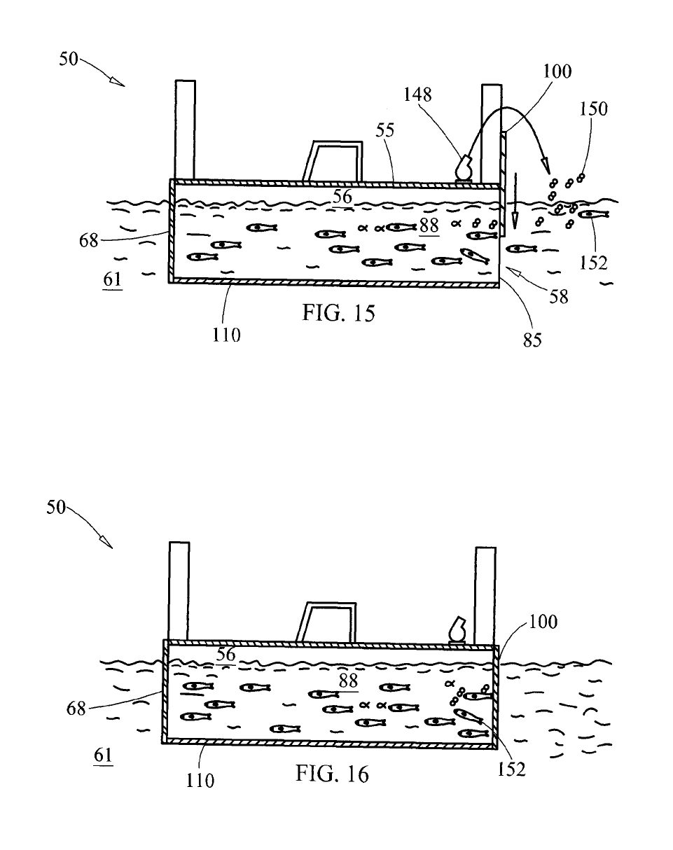

FIG. 15 is a partially sectional, side elevation view of the boat 50 with the gates 68 and 110 fully lowered. The boat 50 in this example includes a pump, in this example a bait pump 148 and bait 150. The bait pump 148 is connected to the deck 55 in this example and disposed in this example adjacent to the second exterior gate 100. The bait pump 148 is configured to pump bait 150 into the water adjacent to the boat 50 and more particularly adjacent to the second exterior gate 100 and the space 88. Bait 150 and fish 152 may pass through opening 85 located by the stern 58 of the boat between the third exterior gate 110, deck 55, and pontoons as indicated by pontoon 56, and into space 88. Fish 152 are attracted to the bait 150 and become entrapped within the enclosure made by the first exterior gate 68, the third exterior gate 110 and the pontoons as indicated by pontoon 56. The second exterior gate 100 may be selectively lowered as shown in FIGS. 15 and 16, causing the fish 152 to be trapped thereby within the space 88 of the boat 50. The boat 50 may then return back to port or a destined market with the fish advantageously kept cool, fresh and/or alive within the water.

Alternatively, to reduce drag, the ballast pumps 136 and 138 as shown in FIG. 9 may be operated to eject water contained within the pontoons 54 and 56, lowering the boat's ballast and causing the boat 50 to return to a lower drag mode thereby. In this case the fish so caught may or may not still be submerged within the water. The water may be drained from space 88.

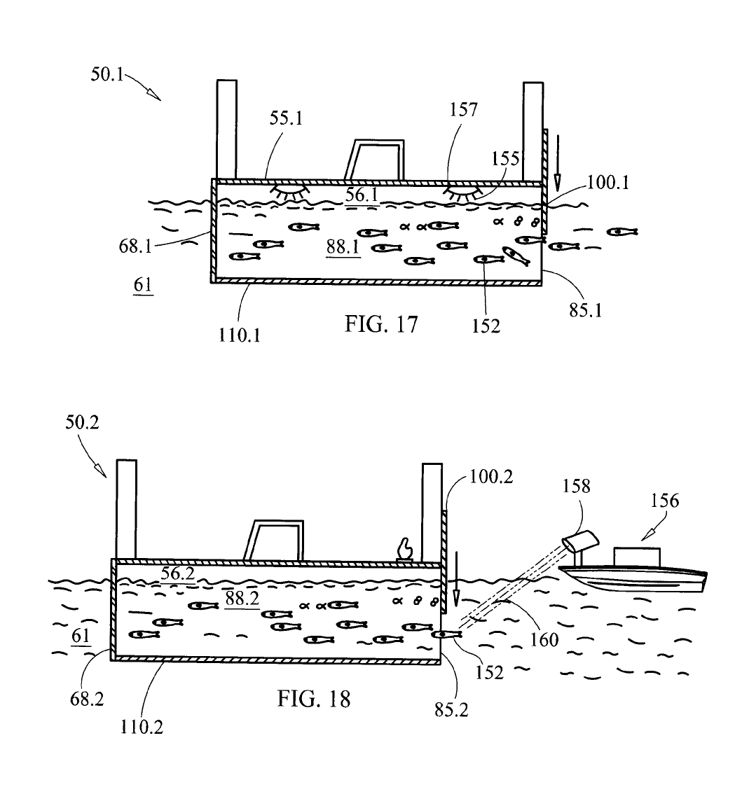

FIG. 17 is a simplified, partially sectional, side elevation view of a multi-hull boat according to a second embodiment. Like parts have like numbers and function as the embodiment of FIG. 1 with the addition of “.1”. Boat 50.1 is substantially the same as boat 50 shown in FIGS. 1 to 16 with the exception being that instead of a bait pump and using bait, the boat includes a plurality lighting apparatuses 157. The lighting apparatuses 157 in this example are mounted to the bottom of deck 55.1 and are disposed to face space 88.1 at least partially enclosed by the first exterior gate 68.1, the third exterior gate 110.1 and the second exterior gate 100.1. The lighting apparatuses 157 direct light 155 to the space 88.1 and at least partially illuminate it with the light 155. Fish 152 are attracted to the light 155, swim through opening 85.1 and into the space 88.1, and the second exterior gate 110.1 may be closed thereafter for trapping the fish 152.

FIG. 18 is a simplified partially sectional, side elevation view of a multi-hull boat according to a third embodiment. Like parts have like numbers and function as the embodiment of FIG. 1 with the addition of “.2”. Boat 50.2 is substantially the same as boat 50 shown in FIGS. 1 to 16 with the exception that instead of a bait pump and using bait a further floating object, in this example a further boat 156, is employed to aid in attracting the fish 152. The further boat 156 has a lighting apparatus 158 mounted thereon. Lighting apparatus 158 is configured to direct light 160 towards, and at least partially through, opening 85.2 to the space 88.2. Space 88.2 is at least partially illuminated thereby. The fish 152 are attracted to the light 160, swim through opening 85.2 to within space 88.2, and may be fully trapped by lowering the second exterior gate 100.2.

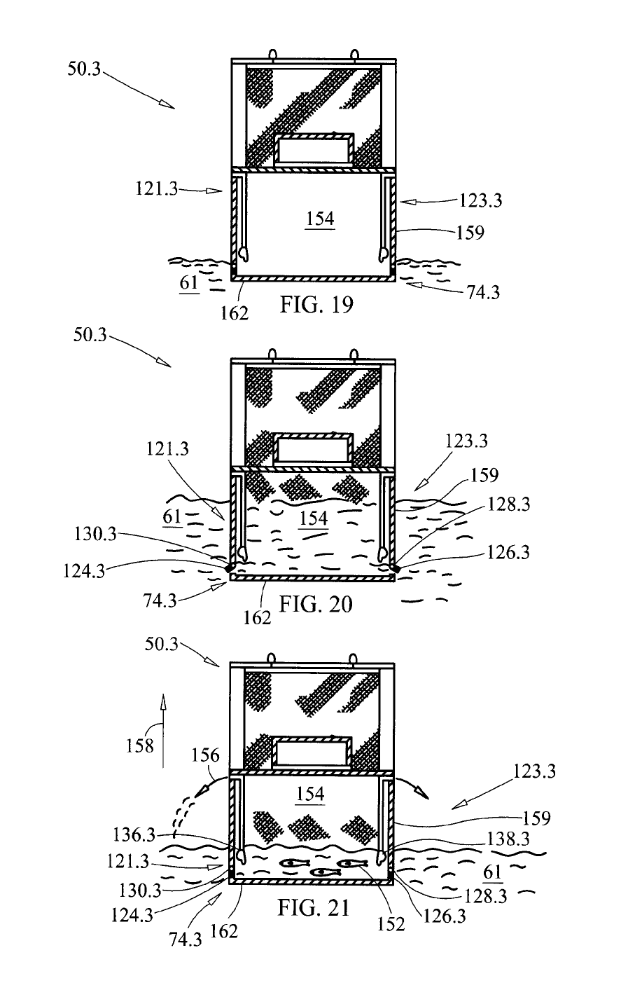

FIGS. 19 to 21 are sectional end views a boat according to a fourth embodiment. Like parts have like numbers and function as the embodiment of FIG. 1 with the addition of “.3”. Boat 50.3 is substantially the same as boat 50 shown in FIGS. 1 to 16 with the exception being that it is monohull boat having a hull 159 rather than a multi-hull catamaran. Also there is no third exterior gate but rather has a fixed bottom wall 162 extending across bottom 74.3 of the boat 50.3 and substantially along the full length of the boat 50.3. Ballast control mechanisms 121.3 and 123.3 operate as previously described with flanges 124.3 and 126.3 being adjustable to selectively cause the boat to become at least partially submerged as shown in FIG. 20. The first exterior gate (not shown) and the second exterior gate (not shown) of the boat 50.3 and the operation of the fishing, with bait and/or lighting, occur as described in relation to the previous embodiments and therefore will not be described further. Once fish 152 shown in FIG. 21 are caught, ballast pumps 136.3 and 138.3 are operable to selectively pump water as indicated by arrow 156 out of hull interior 154 of the boat 50.3. This in turn lowers the boat's ballast, causing the boat to raise upwards, from the perspective of FIG. 21 and as indicated by arrow 158, towards a low drag mode.

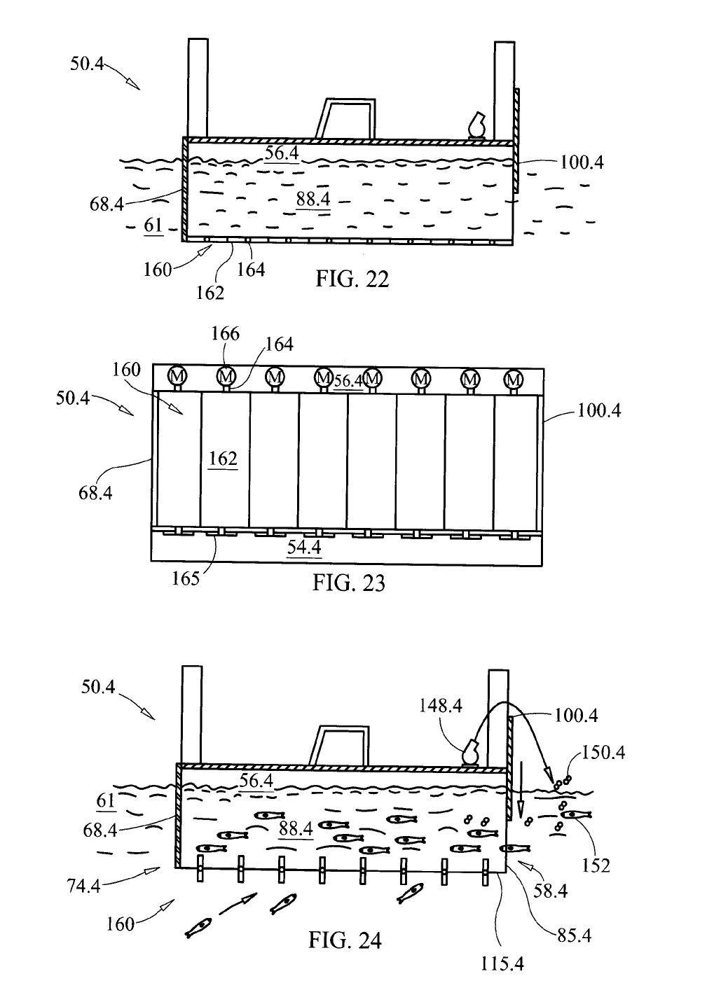

FIGS. 22 to 24 show a multi-hull boat according to a fifth embodiment, with FIGS. 22 and 24 being simplified partially sectional, side elevation views thereof and FIG. 23 being a partially schematic, bottom plan view thereof. Like parts have like numbers and function as the embodiment of FIG. 1 with the addition of “.4”. Boat 50.4 is substantially the same as boat 50 shown in FIGS. 1 to 16 with the exception being that instead of a single third exterior gate 110 there are provided a plurality of axially rotatable gates 160.

Each of the gates 160 has a wall portion 162 that is connected to a pivot rod 164. In this example the wall portion 162 is centrally connected to the pivot rod 164 though this is not required. Referring to FIG. 23 the pivot rods 164 are connected to bearings 165, respectively, which are in turn mounted within pontoon 54.4 in this example. Each of the gates 160 is operatively connected to a motor 166, respectively. The motors 166 are shown schematically. The motors 166 are mounted to pontoon 56.4 in this example. Motors 166 may selectively actuate, or rotate, wall portions 162 via pivot rods 164.

FIGS. 22 and 23 show the gates 160 in closed positions. In this mode fish trapped within space 88.4 are inhibited from passing through the gates 160. FIG. 24 shows the gates 160 in fully open positions. When fishing, bait 150.4 may be pumped into the water adjacent to the second exterior gate 100.4 in this example, which in turn drifts into space 88.4. Advantageously in this embodiment fish 152 may enter space 88.4 via both opening 85.4 by the stern 58.4 of the boat 50.4 and opening 115.4 by the bottom 74.4 of the boat 50.4. This facilitates the ease with which the fish 152 may be caught within the boat 50.4. When sufficient fish 152 are caught within the boat 50.4, the gates 160 are returned to the closed positions shown in FIGS. 22 and 23 and the second exterior gate 100.4 is actuated or lowered to a fully lowered position.

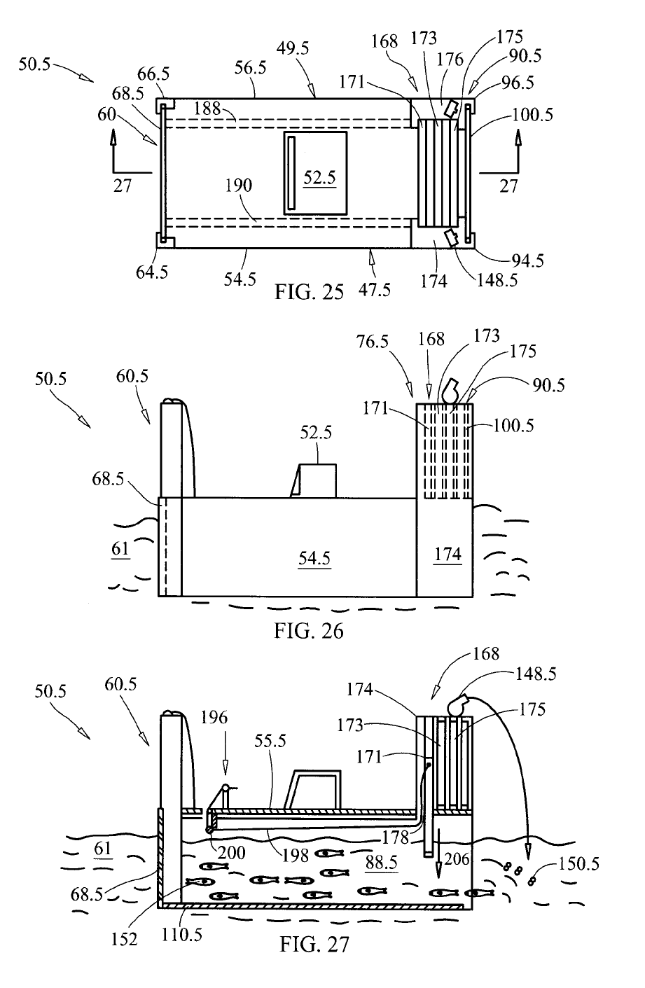

FIGS. 25 to 31 show a multi-hull boat according to a sixth embodiment. Like parts have like numbers and function as the embodiment of FIG. 1 with the addition of “.5”. Boat 50.5 is substantially the same as boat 50 shown in FIGS. 1 to 16 with the exception being that it includes an interior gate mechanism 168 and a plurality of interior gates in this example three gates 171, 173, and 175 being shown. The interior gates may be referred to as fish squeezing gates. The interior gate mechanism 168 includes a storage receptacle, in this example a pair of spaced-apart vertical supports 174 and 176 in this example, being vertical relative to FIG. 26. Support 174 is disposed by the port side 47 of the boat and is connected to pontoon 54.5. Support 176 is disposed by the starboard side 49 of the boat and is connected to pontoon 56.5. In this example supports 174 and 176 of the interior gate mechanism 168 are integral with brackets 94.5 and 96.5, respectively, of the second gate mechanism 90.5. A pair of bait pumps 148.5 in this example are operatively connected to the supports 174 and 176, respectively, by the top 76.5 of the boat, as best shown in FIG. 26. The bait pumps 148.5 are configured to selectively release bait adjacent to the second exterior gate 100.5.

Supports 174 and 176 are shaped to slidably receive the interior gates 171, 173 and 175. FIG. 26 shows the interior gates 171, 173, and 175 in fully raised positions.

As best shown in FIG. 27 the interior gate mechanism 168 includes an aperture, in this example an elongate slot 178 extending through the deck 55.5. The elongate slot 178 is shaped to allow each of the interior gates 171, 173, and 175 to individually pass therethrough as desired. Slot 178 is in communication with space 88.5 that boat 50.5 may selectively enclose.

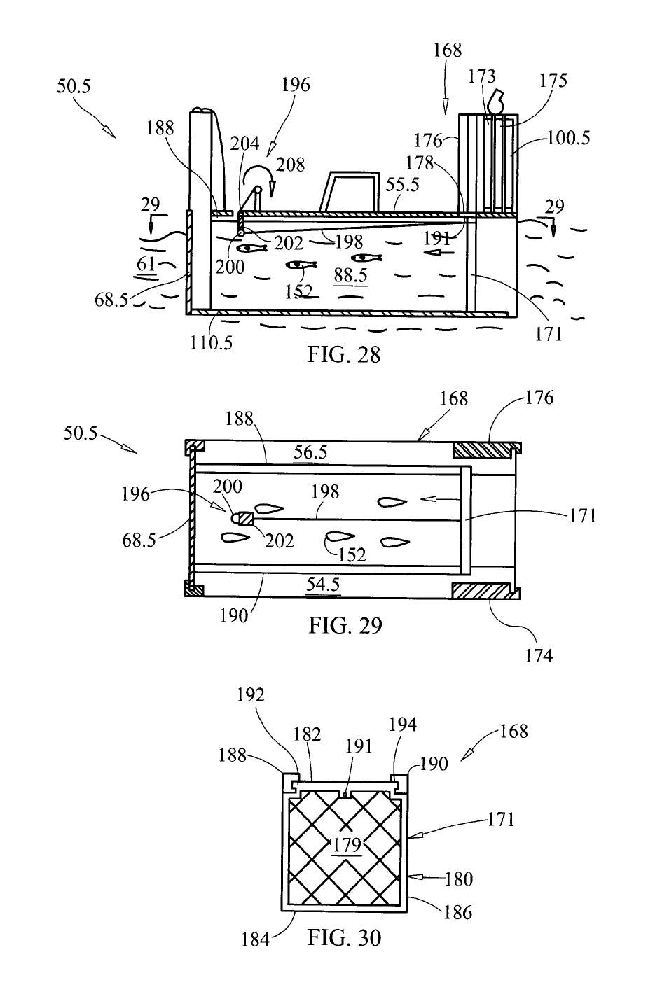

Referring to FIGS. 28 and 29 the interior gate mechanism 168 includes a pair of spaced-apart brackets 188 and 190 in this example for slidably receiving the interior gates 171, 173, and 175. Bracket 188 is operatively connected to pontoon 56.5 and is adjacent to the deck 55.5. Bracket 190 is operatively connected to pontoon 54.5 and is adjacent to the deck 55.5. Brackets 188 and 190 extend from just past the elongate slot 178 shown in FIG. 27 to adjacent to the first exterior gate 68.5 in this example. As best shown in FIG. 30 brackets 188 and 190 are generally u-shaped in cross-section in this example.

An end view of interior gate 171 is shown in FIG. 30 according to one example. Interior gate 171 includes netting 179 in this example and a frame, in this example a rectangular frame 180 connected to and holding the netting 179 in place. The frame 180 in this example has a top portion 182 disposable adjacent to the top of the boat. The frame 180 includes a pair of connector portions in this example spaced-apart projections 192 and 194. The projections 192 and 194 in this example are disposed along opposite ends of the top portion 182 of the frame 180. The frame 180 includes a winch connector, in this example eye 191 connecting to and extending from top portion 182. Brackets 188 and 190 are shaped to slidably receive projections 192 and 194, respectively. The frame 180 has a bottom portion 184 opposite the top portion 182. The frame 180 includes a pair of spaced-apart side portions 186 extending between and connected to both top portion 182 and bottom portion 184.

The interior gate mechanism 168 includes a winch 196 as shown in FIGS. 27, 28 and 29 and rope 198 for selectively connecting to and positioning the interior gates 171, 173, and 175. Rope 198 is connectable to eye 191 of the interior gate 171, shown in FIG. 30 in combination with FIG. 28. The rope 198 passes through pulley 200, which is supported by a projection 202 extending downwards from the deck 55.5, from the perspective of FIG. 28. The rope 198 passes through a further pulley 204 in this example before winding around the winch 196. Winches are known per se by those skilled in the art and therefore will not be described further.

In operation for fishing and referring to FIG. 27, the first exterior gate 68.5 and the third exterior gate 110.5 are in their fully lowered positions in a manner substantially similar to that described for boat 50 shown in FIGS. 1 to 16. Bait 150.5 is pumped into the water adjacent to opening 85.5 via bait pumps 148.5 and the fish get attracted to the bait 150.5, pass through opening 85.5 and become partially entrapped within space 88.5 of the boat. Rope 198 connects to eye 191 of the interior gate 171. The interior gate 171 is aligned with elongate slot 178 and lowered downwards from the perspective of FIG. 27 and as indicated by arrow 206.

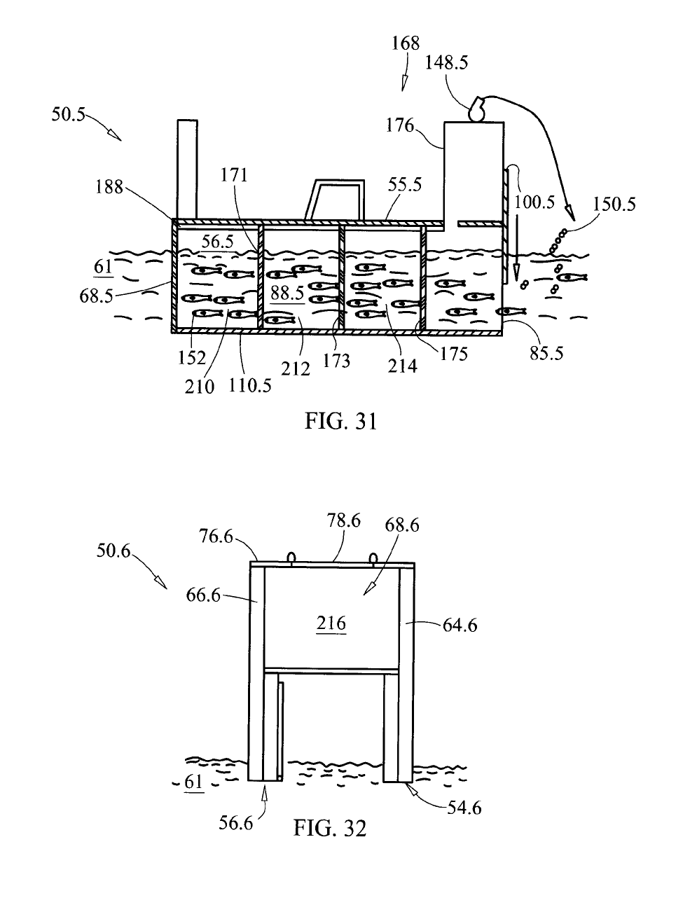

Referring now to FIG. 28 this shows interior gate 171 in a fully lowered position. The winch 196 is actuated as indicated by arrow 208 which thereby causes the rope 198 to coil and at least partially move to the left within space 88.5 and from the perspective of FIG. 28. Referring to FIG. 30 projections 192 and 194 align with and are slidably received by brackets 188 and 190, respectively. Interior gate 171 thus slides along brackets 188 and 190 via the operation of the winch 196. Interior gate 171 thus may act to compartmentalize fish as shown in FIG. 31 with a plurality of compartments 210, 212, and 214. Once one interior gate 171 is in the desired place, the fish to the left of gate 171, from the perspective of FIG. 31, are trapped between the first exterior gate 68.5, the third exterior gate 110.5, interior gate 171 and the pontoons 56.5 within compartment 210. Fishing may be resumed and further interior gates 173 and 175 may be sequentially lowered, with further rope for example, until all of the space 88.5 of the boat 50.5 is enclosed and lastly the second exterior gate 100.5 is lowered to a fully lowered position, covering opening 85.5 thereby.

Boat 50.5 as shown in FIGS. 25 to 31 with its interior gate mechanism 168 and interior gates 171, 173 and 175 provides the advantage of enabling fish caught within, for example, compartment 210 to be compacted together so as to maximize the rest of the space available for catching further fish. Boat 50.5 may thus provide the advantage of increasing the number of fish that may be caught within one fishing trip. Also boat 50.5 provides the advantage of enabling a boat user to segregate different catches and species of fish, which may otherwise interfere, harm or eat each other.

FIG. 32 shows a multihull boat according to a seventh embodiment. Like parts have like numbers and function as the embodiment of FIG. 1 with the addition of “.6”. Boat 50.6 is substantially the same as boat 50 shown in FIGS. 1 to 16 with the exception being that its gates as illustrated by first exterior gate 68.6 comprises a continuous wall 216, instead of a frame and netting. Likewise the second exterior gate may also comprises a wall portion instead of a frame and netting.

Those skilled in the art will appreciate that many variations are possible within the scope of the inventions as herein described. Any number of combinations of bait and/or lighting apparatuses may be employed in the various embodiments as herein described. For example the present disclosure teaches disposing bait pumps 148 adjacent to the second exterior gate 100 for releasing bait adjacent thereto. In addition and/or in the alternative, bait pumps 148 may be disposed adjacent to the first exterior gate 68. In this case either the second exterior gate may remain closed while fish enter or both the first exterior gate and the second exterior gate may remain open for fish to enter and then both gates are closed to catch the fish. Any of the above configurations may be combined with any number of lighting apparatuses for attracting even more fish.

In a further variation bait may be released directly into space 88 by for example, providing an aperture in the deck 55 for the release of bait therethrough or by for example mounting a bait pump 148 to the deck 55 such that the bait pump 148 is disposed within space 88. In yet a further variation such bait release configurations may be combined with of those set out in the preceding paragraph and/or in combination with any number of lighting apparatuses configurations for attracting even more fish.

These and other bait pump with bait configurations and/or lighting apparatuses configurations may be referred to a means for attracting fish into the hull interior 154.

While in the above described embodiments it is the first gate mechanism, the second gate mechanism and the interior gate mechanism which have the brackets for receiving the first exterior gate, the second exterior gate and the interior gates, respectively, alternatively the frames of the gates may themselves be shaped like brackets and be slidably mounted to the gate mechanisms via frame portions of the gate mechanisms.

While pairs of brackets are described in the first gate mechanism 60, the second gate mechanism 90 and the interior gate mechanism 168, in the alternative only one bracket per mechanism can be used to the same effect.

Instead of brackets a series of rollers may used to manipulate the gates from closed positions to open positions.

The interior gate mechanism 168 in the alternative may be disposed towards the bow of the boat as opposed to the stern. In a further alternative the boat may include a pair of spaced-apart interior gate mechanisms disposed by the bow and stern, respectively, with a plurality of interior gates mounted therein and slidable from the bow and/or stern.

Eye 191 per se is not required. For example the rope 198 may be tied to and thereby connect to, for example, the top portion 182 of the frame 180.

The plurality of axially rotatable gates 162 shown in FIGS. 22 to 24 are disposed transversely, being mounted so as to each extend from one pontoon to the other. In the alternative the plurality of axially rotatable gates may be disposed longitudinally, being mounted to extend in parallel with the pontoons. Put another way the gates may be disposed to each extend from the bow of the boat towards the stern of the boat. A cross member adjacent to one of the bow and stern may extend across the pontoons and have mounted thereon a plurality of bearings. Likewise a further cross member adjacent to another of the bow and stern may extend across the pontoons and have mounted thereon a plurality of motors for selectively actuating, or rotating, the plurality of so disposed gates.

The plurality of axially rotatable gates 162 shown in FIGS. 22 to 24 may be combined with the monohull boat 50.3 shown in FIGS. 19 to 21. In a further variation the axially rotatable gates 162 may be combined with a monohull boat similar to that shown in FIGS. 19 to 21 with the exception being that the flanges 124.3 and 126.3 and motors 130.3 and 128.3 would no longer be required. This is because the gates 162 may be selectively adjustable to take in water within the boat's interior as required so selectively partially submerge the boat. In yet a further alternative the first gate mechanism and the second gate mechanism may further be omitted with fish selectively entering within the interior of the boat via the axially rotatable gates attracted to either bait and/or light released into the interior of the boat.

In a further variation to boat 50.3 shown in FIGS. 19 to 21, instead of flanges 121.3 and 123.3, boat 50.3 may employ a third exterior gate as described in FIGS. 1 to 16 that is selectively actuated to partially open and allow water 61 to enter within hull interior 154 and lower the boat thereby in order to fish.

In a variation to the embodiment shown in FIGS. 22 to 24, instead of and/or in addition to bait, lighting apparatuses may be used to also attract the fish as for example shown in FIGS. 17 and 18. Furthermore instead of wall portions 162 a plurality of gates comprising frames and netting stretched out therebetween, similar to that shown in FIG. 3, may be used.

In any of the various embodiments of the boat floatation devices may be further incorporated into the design as required and/or desired for even further ballast control and/or safety.

While the above set out description has disclosed catching fish, it will be appreciated that the fishing boats as herein described may also be used catch many other varieties of marine life of commercial and/or scientific interest, including whales, squid, shrimp, sardines, maqueral and the like.

The first gate mechanism 60 and first exterior gate 68, the second gate mechanism 90 and second exterior gate 100, and the third gate mechanism 116 and third exterior gate 110 may be retrofittable onto existing fishing boats and/or existing catamaran boats.

In one example the boat may have a length of 50 meters and a width of 25 meters with pontoons extending downwards from the deck 55, relative to FIG. 2, to a distance of 20 meters. Alternatively the boat may have a length of, for example, 300 meters and a width of 150 meters. These dimensions are provided by way of example only.

It will be understood by someone skilled in the art that many of the details provided above are by way of example only and are not intended to limit the scope of the invention which is to be determined with reference to the following claims.

What is claimed:

1. A multi-hull fishing boat having a bow, a stern opposite the bow and a bottom and comprising:
a pair of spaced-apart pontoons operatively connected together;
a first gate near the bow of the boat configured to selectively extend across the space between the pair of pontoons;
a second gate near the stern of the boat configured to selectively extend across the space between the pair of pontoons; and
a third gate configured to selectively extend across the space between the pair of pontoons by the bottom of the boat, the first gate, the second gate, the third gate and the pair of pontoons forming an enclosure for trapping fish.

2. The boat as claimed in claim 1 further including means for selectively opening at least one of the first gate, the second gate and the third gate to allow fish to enter the enclosure.

3. The boat as claimed in claim 1 including means for selectively moving the first gate, the second gate and the third gate from open positions in which the first gate, the second gate and the third gate are at least partially removed from surrounding water to closed positions to inhibit fish from exiting the enclosure.

4. The boat as claimed in claim 1 further including a bait pump configured to selectively release bait into the water and attract fish thereby.

5. The boat as claimed in claim 1 further including a light apparatus for selectively emitting light, the lighting apparatus being positioned to at least partially illuminate the enclosure.

6. The boat as claimed in claim 1, the pair of pontoons being at least partially hollow and the boat further including a pair of ballast pumps disposed within the pair of pontoons, the pair of ballast pumps being configured to selectively pump water into and out of the pair of pontoons for controlling the buoyancy of the boat thereby.

7. The boat as claimed in claim 1 including a means for selectively submerging the pair of pontoons into the water, the enclosure increasing in size as the boat becomes more submerged, thereby increasing the space within which fish may be caught.

8. The boat as claimed in claim 1 further including a first gate mechanism for mounting and selectively lowering the first gate, the first gate mechanism being disposed near the bow of the boat, one of the first gate and the first gate mechanism including an elongate frame portion and the other of the first gate and the first gate mechanism including an elongate bracket shaped to receive the elongate frame portion, the first gate being slidably mounted to the first gate mechanism, one of the elongate frame portion and the bracket being so disposed as to enable the first gate to move from a fully raised position in which the first gate is out of the water and to a fully lowered position in which the first gate covers the space between the pair of pontoons by the bow of the boat.

9. The boat as claimed in claim 8 further including a second gate mechanism for mounting and selectively lowering the second gate, the second gate mechanism being disposed near the stern of the boat, one of the second gate and the second gate mechanism including an elongate frame portion and the other of the second gate and the second gate mechanism including an elongate bracket shaped to receive the elongate frame portion of the one of the second gate and the second gate mechanism, the second gate being slidably mounted to the second gate mechanism, the second gate mechanism being so disposed as to enable the second gate to move from a fully raised position in which the second gate is out of the water and to a fully lowered position in which the second gate spans the space between the pair of pontoons by the bow of the boat.

10. The boat as claimed in claim 1 wherein the third gate comprises a plurality of axially rotatable gates and a plurality of motors operatively connected thereto, the plurality of motors being configured to selectively open and close the plurality of gates.

11. The boat as claimed in claim 1 wherein the boat is a catamaran.

12. The boat as claimed in claim 1 further including a plurality of interior gates configured to selectively compartmentalize portions of the enclosure having fish caught therewithin, fish so caught being compacted thereby.

13. The boat as claimed in claim 1 further including a deck extending across the pair of pontoons, an interior gate and an interior gate mechanism for mounting and selectively lowering the interior gate, the interior gate being shaped to extend across the space between the deck, the third gate and the pair of pontoons, one of the interior gate mechanism and the interior gate including one of a bracket and a connector portion disposed adjacent to the enclosure and at least partially extending between the bow and the stern, and another of the interior gate mechanism and the interior gate including another of the bracket and the connector portion, the bracket being shaped to receive the connector portion, the interior gate being slidably mountable to the interior gate mechanism thereby.

14. A fishing boat for capturing fish comprising:
a hollow hull with a hull interior and an opening for communication with the hull interior and surrounding water;
a gate adjacent to the opening, the gate being configured to open and allow water to at least partially enter into the hull, the boat becoming more submerged thereby; and
a means for attracting fish into the hull interior, the gate being configured to selectively close and capture the fish.

15. The fishing boat as claimed in claim 14 wherein the means for attracting fish includes a pump, the pump being disposed to pump bait into the water adjacent to the opening.

16. The fishing boat as claimed in claim 14 wherein the means for attracting fish includes lighting configured to at least partially illuminate the hull interior.

17. The fishing boat as claimed in claim 14 wherein the means for attracting fish includes lighting configured to at least partially illuminate outside of the boat to attract fish and configured to slowly move light towards the hull interior for directing the fish therein.

18. The fishing boat as claimed in claim 15 wherein the means for attracting fish further includes lighting configured to at least partially illuminate the hull interior.

19. A method of fishing for a catamaran fishing boat having a bow, a stern opposite the bow, a bottom and a pair of pontoons, the method comprising:
configuring the fishing boat with a first gate, a second gate and a third gate which are selectively positionable and extendable between the pair of pontoons adjacent the bow, the stern and the bottom of the boat, respectively, an enclosure being formed thereby;
positioning and extending at least one of the first gate, the second gate and the third gate between the pair of pontoons;
deploying one of bait and light adjacent to one of the gates while said one of the gates is at least partially open so as to attract fish thereby; and
so positioning and extending the gates, apart from said one of the gates, between the pair of pontoons in such a manner as to catch the fish within the enclosure.
